(19) United States
(12) Patent Application Publication
(10) Pub. No.: US 2022/0323933 A1
(43) Pub. Date: Oct. 13, 2022

(54) SINTERED POROUS ELASTOMERIC MATERIAL AND APPLICATION OF THE SAME

(71) Applicant: Porex Corporation, Fairburn, GA (US)

(72) Inventors: Saman Mahdavi Shahidani, Decatur, GA (US); Xingguo Li, Peachtree City, GA (US); Luis Angel Pagán, Atlanta, GA (US); Rahul Maharsia, Peachtree City, GA (US); Guoqiang Mao, Peachtree City, GA (US)

(21) Appl. No.: 17/642,352

(22) PCT Filed: Sep. 23, 2020
(86) PCT No.: PCT/US2020/052286

§ 371 Date: Mar. 11, 2022

Related U.S. Application Data
(60) Provisional application No. 62/904,172, filed on Sep. 23, 2019.

(51) Int. Cl. B01J 20/26; B01J 20/20; B01J 20/18; B01J 20/28; B01J 20/30; H01M 4/96

(52) U.S. Cl. CPC B01J 20/262; B01J 20/20; B01J 20/18; B01J 20/28011; B01J 20/3078; H01M 4/96

(57) ABSTRACT

A sintered elastomeric material combined with at least one absorbent material and formed into a thin compressible sheet. The material finds particular use in venting or filtering gasses. In specific examples, the elastomeric material may be a thermoplastic elastomer and the absorbent material may be carbon. When an amount of carbon (or any other type of conductive material) included with the elastomeric material is high enough, the material may also find use as a conductive material.

This application claims the benefit of U.S. Provisional Application Ser. No. 62/904,172, filed Sep. 23, 2019, titled “Sintered Porous Elastomeric Material and Application of the Same,” the entire contents of which are hereby incorporated by reference.

### FIELD OF THE DISCLOSURE

According to certain embodiments of this disclosure, there is provided a sintered elastomeric material combined with at least one absorbent material and formed into a thin compressible sheet. The material finds particular use in venting or filtering gasses. In specific examples, the elastomeric material may be a thermoplastic elastomer and the absorbent material may be carbon. When an amount of carbon (or any other type of conductive material) included with the elastomeric material is high enough, the material may also find use as a conductive material.

### BACKGROUND

Sintered porous elastomers have been used as liquid applicators in writing and cosmetic fields. U.S. Pat. No. 8,141,717 disclosed materials and methods of making sintered porous elastomeric material by mixing elastomeric particles and other solid particles together and sintering. This sintered porous material can be used in liquid applicators and filters.

JP 1987225325A disclosed making a porous rubber elastic body by sintering expanded or nonexpanded vulcanized rubber powder with hot melt particles.

U.S. Pat. No. 4,306,033 disclosed a highly hydrophilic and porous sintered body made of thermoplastic polyacrylonitrile resins for stamping.

WO 2004/062531 disclosed using a reticulated elastomeric matrix for use as an implant. The pores encourage cellular ingrowth.

All of the above products are molded, and are thus, relatively thick and not necessarily pliable. In many applications, however, a thin and flexible porous media with good mechanical strength and elasticity is needed. The present disclosure addresses these needs.

### SUMMARY

Accordingly, the present inventors have designed an elastomeric material that has excellent compressibility and venting properties, with a thinness that allows the material to be formed into a particular desired shape. The elastomeric material may be a thermoplastic elastomer (TPE), such as thermoplastic urethane (TPU) combined with an absorbent material, such as carbon.

### BRIEF DESCRIPTION OF THE DRAWINGS

FIG. 1 shows a perspective view of a sheet of sintered porous elastomeric material having carbon particles combined therein.

FIG. 2 shows a perspective view of the material of FIG. 1 being rolled to illustrate flexibility and compressibility.

### DETAILED DESCRIPTION

The present disclosure relates to a sintered thin sheet of elastomeric porous material or media for providing improved venting, conducting (thermal and electrical), filtering, wicking, applying, and adsorption, absorption and protection related applications. In a specific example, the material may be used in connection with an electrode/anode for a battery. A specific embodiment may be used as a fuel cell battery anode. Prior battery anodes have been made of polymer as a binder/base with a slurry or other type of coating of carbon applied thereto. These materials, however, do not use a sintered porous polymer as the base. These materials also are not flexible or compressible. These materials also do not have carbon incorporated into the base material.

In one specific example, the porous elastomeric media may be manufactured out of a thermoplastic elastomer (TPE). An even more specific example manufactures the porous elastomeric material out of thermoplastic urethane (TPU). Other elastomeric media are possible and considered within the scope of this disclosure, as outlined below. In the specific example described here, the TPU may be sintered with an absorbent material. In one specific example, the absorbent material may be carbon particles or media. If elastomers other than TPU are used, it is also possible for the elastomeric material to be sintered with carbon particles or media. (Additionally or alternatively, in other examples, it is possible for the TPU to be layered with carbon particles or media.)

In order to provide one exemplary desired electrical conductivity, the amount of carbon used may be in the range of over 70%. (This is a higher range than carbon used for filtration purposes, which is usually in the range of about less than 60%.) Using TPU with a higher percentage of carbon incorporated therein (and/or applied thereto) can provide a conductive product that can be flexed or formed into a desired shape, such as an electrode.

In other examples, if conductivity is not required, the TPU or other type of elastomeric material may be sintered with carbon particles or media in the range of about 10-60% carbon. These lower carbon compositions may be useful as gas absorptive media for its high mechanical strength and with less loose particles, described in more detail below.

The compressibility of the material is provided by the use of TPU or other elastomeric materials instead of the typical plastic binders. The conductivity may be provided by carbon. It is also possible to compound or otherwise combine different or additional conductive materials into the TPU (or other elastomeric material) binder. Non-limiting examples of potential additional conductive materials include active carbon, graphene, graphite, any combination thereof, or any other appropriate conductive material.

The present disclosure thus provides a new porous media made from sintered porous elastomeric material combined with carbon particles or media. The resulting media provides an overall advantage in cost, flexibility, mechanical strength, elasticity, and assembly performance over other products already on the market, such as cellulose papers, glass fibers, synthetic fibers, woven or nonwoven based porous thin sheet materials and flexible open-cell foam sheet materials.

The sintered thin porous elastomeric material disclosed can be used in venting, conducting (thermal and electrical), filtering, wicking, applying, absorbing and protecting related applications. For example, the material may be positioned with respect to a gas sensor. The material may function as a sensor filter media. The pore sizes and material thickness may be designed such that a first type of gas is allowed to pass through the material and a second type of gas is absorbed into the matrix of the material. This can allow the material to be used to remove certain organic gasses but allow other inorganic gasses to pass through (or vice versa). In other examples, the material can be used to absorb all alcohol gasses but allow other types of gasses to pass through. The amount of absorptive material combined with the elastomeric material can be modified in order to increase or decrease absorption properties of the media. For example, more carbon may be loaded into the material in order to increase absorption of certain gasses, particles, or certain types of molecules. Changing the pore size by varying the amount, time, and temperature of compression applied to the material during formation can alter the air flow rate of gas (and type of gas absorbed or passed) through the material.

Exemplary elastomers suitable for use in sintered elastomeric porous media of the present disclosure, according to some embodiments, comprise thermoplastic elastomers (TPE). Thermoplastic elastomers, in some embodiments, comprise polyurethanes and thermoplastic polyurethanes (TPU). Thermoplastic polyurethanes, in some embodiments, include multiblock copolymers comprising a polyurethane and a polyester or polyether.

In other embodiments, elastomers suitable for use in sintered porous polymeric components of the present disclosure comprise polyisobutylene, polybutene, butyl rubber, or any combinations thereof. In another embodiment, elastomers comprise copolymers of ethylene and other polymers such as polyethylene-propylene copolymer, referred to as EPM, polyethylene-octene copolymer, and polyethylene-hexene copolymer, or any combinations thereof. In a further embodiment, the elastomers may comprise chlorinated polyethylene or chloro-sulfonated polyethylene, or any combination thereof.

In some embodiments, elastomers suitable for use in sintered porous polymeric components of the present disclosure comprise 1,3-dienes and derivatives thereof 1,3-dienes include styrene-1,3-butadiene (SBR), styrene-1,3-butadiene terpolymer with an unsaturated carboxylic acid (carboxylated SBR), acrylonitrile-1,3-butadiene (NBR or nitrile rubber), isobutylene-isoprene, cis-1,4-polyisoprene, 1,4-poly(1,3-butadiene), polychloroprene, and block copolymers of isoprene or 1,3-butadiene with styrene such as styrene-ethylene-butadiene-styrene (SEBS). In other embodiments, elastomers comprise polyalkene oxide polymers, acrylics, or polysiloxanes (silicones) or combinations thereof.

In various embodiments, the elastomers used to make the sintered porous elastomeric material body can be selected from the group consisting of hydrogenated styrenic block copolymers, such as Septon® from Kuraray Co., Ltd. (Pasadena, Tex,); co-polyester based elastomers, such as Hytrel® from DuPont (Wilmington, Del.) and Arnitel from DSM (Troy, Mich.); styrene-butadiene-styrene block copolymers, such as Kraton® from Kraton Corporation (Houston, Tex.), Solprene from Dynasol (Houston, Tex.) and Dryflex® from Hexpol (Sandusky, Ohio); copolymer of ethylene-octene, such as Engage® from Dow Chemical (Midland Mich.); thermoplastic polyurethane such as Irogran®, Avalon®, Krystalgran®, and Irostic® from Huntsman (The Woodlands, Tex.), Desmopan®, Texin®, Desmoflex® and Desmovit® from Covestro (Pittsburgh, Pa.), Elastollan® from BASF (Florham Park, N.J.) and Estane®, Estloc™, and Pearthane™ from Lubrizol (Breckville, Ohio); silicone based elastomers, such as TPSiV®, from Dow Corning (Midland, Mich.), ethylene-vinyl-acetate (EVA), such as Elevate® from Westlake Chemical (Houston, Tex.) and polypropylene based elastomer, such as Vistamaxx from ExxonMobile (Spring, Tex.). Other elastomeric materials known to one of ordinary skill in the art may be used. Combinations of any of the above-described materials may also be used.

A sintered porous elastomeric component, according to some embodiments of the present disclosure, comprises at least one elastomer.

A sintered porous elastomeric component, according to some embodiments of the present disclosure, comprises a mixture of different elastomers.

A sintered porous elastomeric component, according to some embodiments of the present disclosure, comprises at least one elastomer and another type of solid particle.

The solid particles could be plastic particles, fillers, colorants, absorptive particles, such as silica, active carbons, metal oxide framework (MOF), molecular sieves, zeolites polystyrene-based absorptive resins, or any combination thereof.

Silica could be any powder form silica with porous pore size from 2 nm to 300 nm with surface areas from 5 m²/g to about 800 m²/g.

Absorptive active carbons could be any active carbon with Iodine number above 500 mg/g. This type of active carbon is widely available from Calgon corporation, Cabot corporation Haycarb corporation, Puragen corporation, Jacobi corporation.

Conductive carbon and its derivatives could be any powder form carbon with high conductivity, such as carbon black, nanocarbon tube, graphites, or any combination thereof.

The conductivity is above 0.01 S/cm

It is possible for the thermoplastic elastomer (or elastomeric particles) to be combined with other materials. In one example, the elastomeric particles have an amount ranging from about 10 weight percent to about 90 weight percent. In other embodiments, a sintered porous polymeric component comprises at least one elastomer in an amount ranging from about 20 weight percent to about 80 weight percent. In another embodiment, a sintered porous polymeric component comprises at least one elastomer in an amount ranging from about 30 weight percent to about 70 weight percent. In a further embodiment, a sintered porous polymeric component comprises at least one elastomer in an amount ranging from about 40 weight percent to about 60 weight percent.

The sintered thin porous elastomeric materials may have a porosity ranging from about 5% to about 80% or from about 10% to about 70%. In a further embodiment, a sintered porous polymeric component comprising at least one plastic and at least one elastomer has a porosity ranging from about 2% to about 60%.

The sintered porous elastomeric materials may have an average pore size ranging from about from about 1 μm to about 200 μm. In other embodiments, the sintered porous elastomeric materials have an average pore size ranging from about 2 μm to about 150 μm, from about 5 μm to about 100 μm, or from about 10 μm to about 50 μm. In another embodiment, the sintered porous elastomeric materials have an average pore size less than about 1 μm.

The sintered porous elastomeric materials, according to some embodiments, may have a density ranging from about 0.1 g/cm3 to about 1 g/cm3. In other embodiments, the sintered porous elastomeric materials have a density ranging from about 0.2 g/cm3 to about 0.8 g/cm3 or from about 0.4 g/cm3 to about 0.6 g/cm3. In a further embodiment, the sintered porous elastomeric materials have a density greater than about 1 g/cm3.

In some embodiments, the sintered porous elastomeric materials may have a rigidity according to ASTM D747 of less than about 15 psi. In other embodiments, the sintered porous elastomeric materials have a rigidity according to ASTM D747 of less than about 10 psi. In a further embodiment, the sintered porous elastomeric materials have a rigidity according to ASTM D747 of less than about 5 psi. In another embodiment, the sintered porous elastomeric materials have a rigidity according to ASTM D747 of less than about 1 psi.

Moreover, in some embodiments, the sintered porous elastomeric materials may have a tensile strength ranging from about 10 to about 5,000 psi as measured according to ASTM D638. The sintered porous elastomeric materials have a tensile strength ranging from about 50 to 3000 psi or from about 100 to 1,000 psi as measured according to ASTM D638.

In some embodiments, the sintered porous elastomeric materials may have an elongation from ranging from 10% to 500%. This may be based on various standards, such as ASTM D412.

The sintered porous elastomeric materials of this disclosure may be hydrophilic, hydrophobic and even with oleophobic properties.

In a specific embodiment, the sintered porous elastomeric material comprises elastomeric particles and high surface area adsorptive or absorptive particles.

In a further embodiment, the absorptive particles are active carbons, molecular sieve and high surface area polystyrene based resins, polyacrylate based resins.

In a further embodiment, the elastomeric particles of this disclosure may be electric conductive, thermal conductive or both electric and thermally conductive.

The sintered porous elastomeric materials of this disclosure may be compounded and electric conductive, thermal conductive or both electric and thermally conductive. The electric conductivity for the sintered porous media in present disclosure could be from 10-2 to 10-12 S/M, from 10-4 to 10-10 S/M, or from 10-6 to 10-8 S/M.

The high surface area adsorptive or absorptive particles may be useful for removing vapors, gases, or poison gases for an air flow across the material. The particles used for removing or absorbing vapors or gases could be active carbons, molecular sieves, polymeric absorptive resins, such as polystyrene/divinylbenzene based absorptive or ion exchange resins.

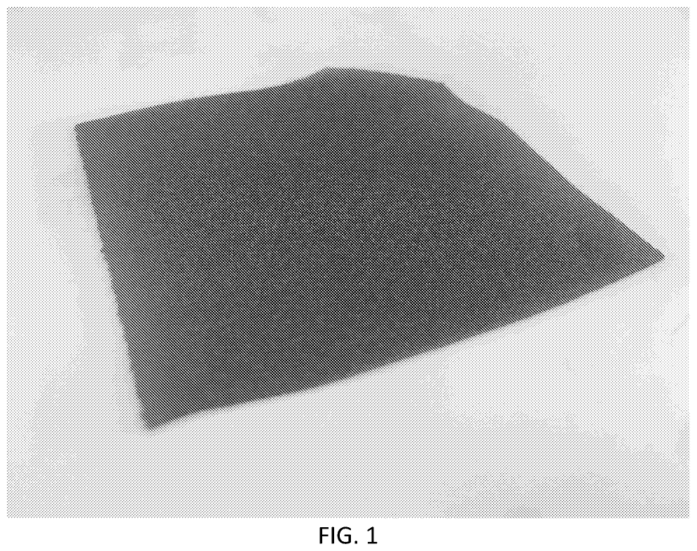

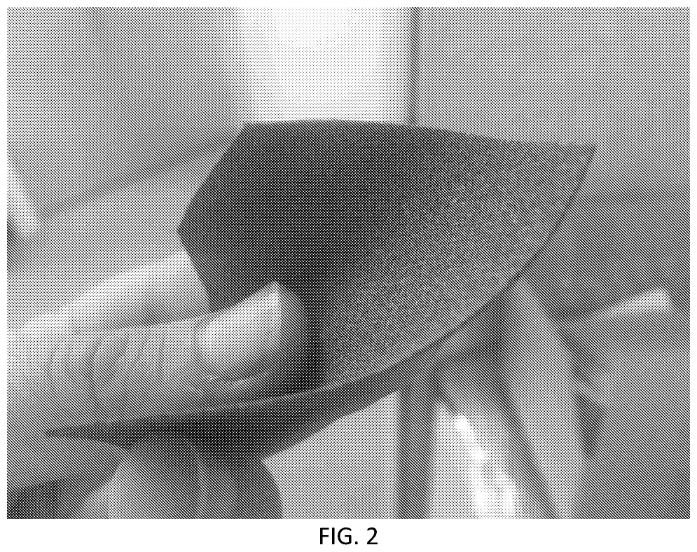

In another specific embodiment of present disclosure, the sintered porous elastomeric material of the present disclosure is provided in a thin sheet form. The thickness of sintered porous elastomeric media in present disclosure may be from about 50 microns to 5000 microns, or from 100 microns to 2000 microns, or from 500 microns to 1000 microns. The general goal is that use of elastomeric particles allows the resulting material to be compressible and thin. The material may be formed via sintering and compression. The compression can flatten the material into a sheet-like form that can be cut by an end user. An exemplary sheet of material is illustrated by FIG. 1. Once formed or cut into the desired shape, the material can be rolled or compressed, as illustrated by FIG. 2. The thinness of the material allows it to be positioned into a filter or sensor or other gas venting feature.

Various combinations of any of the above embodiments are also considered within the scope of this disclosure and the accompanying claims.

The materials of present invention could be laminated to other substrates by heating or through adhesives.

### Method of Making

Porous elastomeric materials and any additional additive particles in some embodiments, may be sintered at a temperature ranging from about 93° C. to about 371° C. In specific examples, the elastomeric particles may be TPE or TPU particles. In specific examples, the additive particles may be carbon particles. In some embodiments, additives particles and elastomer particles are sintered at a temperature ranging from about 149° C. to about 260° C. The sintering temperature, according to embodiments of the present invention, is dependent upon and selected according to the identity of the additive and elastomer particles.

Elastomer particles and additive particles, in some embodiments, are sintered for a time period ranging from about 30 seconds to about 30 minutes. In other embodiments, additive particles and elastomer particles are sintered for a time period ranging from about 1 minute to about 15 minutes or from about 5 minutes to about 10 minutes. In some embodiments, the sintering process comprises heating, soaking, and/or cooking cycles. Moreover, in some embodiments, sintering of additive and elastomer particles is conducted under ambient pressure (1 atm). In other embodiments sintering of plastic and elastomer particles is conducted under pressures greater than ambient pressure.

### EXAMPLE 1

A Hydralight® fuel cell battery was purchased from Amazon. The battery was disassembled and original carbon anode was removed and replaced with three different sintered porous elastomeric and plastic conductive media loaded with active carbon. The battery's voltages were measured.

TABLE 1
Voltage of the battery and conductivity of sintered porous materials

| | | Conductivity |
|---|---|---|
| Sample | Voltage | (Siemens)* |
| Original Hydralight ® battery | 1.75 V | 0.0067 |
| 0.6 mm thick sintered porous | 1.50 V | 0.025 |
| conductive sheet with 85% carbon | | |
| 1.2 mm thick sintered porous | 1.60 V | 0.0025 |
| conductive sheet with 85% carbon | | |
| 1.2 mm thick sintered porous | 1.50 V | 0.0025 |
| conductive flexible sheet with 70% carbon | | |

*The conductivities were measured with a multimeter, two electrodes were 1 cm apart on the same side of samples.

### EXAMPLE 2

Sintered porous TPU elastomer material with active carbon for removing H₂S

TPU with average particle size of about 100 microns and active carbon with average particle size of 70 microns were mixed at the weight ratio of 70% to 30%. The mixtures were filled into a mold with open of a thickness of 3.2 mm and sintered at 160° C. for 5 minutes. The resulted sheets were sequentially compressed to 2.4 mm and 1.6 mm.

The basic physical properties of above product are shown in Table 2.

TABLE 2
Physical properties of sintered porous TPU
with active carbon with different compression ratios.

| | Thickness | Com- | Pore Size | Pore | Tensile | Bending | Air Flow* |
|---|---|---|---|---|---|---|---|
| Sample | (mm) | pression | (microns) | volume 9 | (PSI) | (Degree) | (mm/Min) |
| Sample 1 | 3.2 | 0 | 66 | 54 | 24 | 85** | 1276 |
| Sample 2 | 2.4 | 25 | 35 | 51 | 100 | 48** | 1247 |
| Sample 3 | 16 | 50 | 29 | 37 | 644 | 21** | 156 |

**tested under 25 g of loading and specimen is 1.25 cm wide.
*Air flow is at 1 inch of water

H₂S removal properties of sintered TPU with active carbon with different compression ratios are in table 3

TABLE 3
H₂S removal for sintered porous TPU with active carbon at
different compression ratios.

| | | | H2S | H2S | Minutes |
|---|---|---|---|---|---|
| | Thickness | | flow rate | challenge | remains 0 |
| Sample | (mm) | Compression | (ml/m | (ppm) | PPM |
| Sample 1 | 3.2 | 0 | 80 | 32 | 106 |
| Sample 2 | 2.4 | 25 | 80 | 32 | 94 |
| Sample 3 | 16 | 50 | 80 | 32 | 92 |
| Sample 1 | 3.2 | 0 | 250 | 32 | 19.8 |
| Sample 2 | 2.4 | 25 | 250 | 32 | 22.5 |
| Sample 3 | 16 | 50 | 250 | 32 | 18 |

### EXAMPLE 3

Sintered porous TPU elastomer material with active carbon and molecular sieve

TPU with average particle size of about 200 microns, active carbon with average particle size of 70 microns and 4 Å with average particle size of 40 microns are mixed at the weight ratio of 60%, 30% and 20%. The mixtures are filled into a mold with open of a thickness of 3.2 mm and sintered at 160° C. for 5 minutes. The product has about macro pore size of 90 microns and 50% pore value

1. A sintered porous elastomeric material, comprising an elastomeric material and at least one absorbent material, wherein the sintered porous elastomeric material is flexible and compressible and with thickness less than 5 mm.

2. The material of claim 1, wherein the at least one absorbent material comprises silica, active carbons, metal oxide framework (MOF), molecular sieves, zeolites, polystyrene-based absorptive resins, or any combination thereof.

3. The material of claim 1, wherein the at least one absorbent material comprises 10-60% of the material.

4. The material of claim 1, wherein the at least one absorbent material comprises over 70% of the material.

5. The material of claim 1, wherein the elastomeric material comprises thermoplastic elastomers.

6. The material of claim 1, wherein the elastomeric material comprises thermoplastic polyurethane.

7. A sintered porous elastomeric material, comprising elastomeric material and at least one conductive material, wherein the sintered porous elastomeric material is flexible and compressible and with thickness less than 5 mm and have a conductivity above 10-6 S/M
